(19) United States
(12) Patent Application Publication
(10) Pub. No.: US 2008/0247366 A1
(43) Pub. Date: Oct. 9, 2008

(54) Forced silencing of transmitting device

(76) Inventors: Ulrico Celentano, Oulu (FI); Harald Kaaja, Jarvenpaa (FI); Juha Salokannel, Tampere (FI)

Correspondence Address: BRAKE HUGHES BELLERMANN LLP, c/o INTELLEVATE, P.O. BOX 52050, MINNEAPOLIS, MN, 55402, US

(21) Appl. No.: 11/527,778

(22) Filed: Sep. 26, 2006

(51) Int. Cl. H04Q 7/24

(52) U.S. Cl. 370/338

(57) ABSTRACT

Various embodiments are described relating to sharing scanning operations among nodes in a wireless network, such as a WiMedia ultra-wideband (UWB) network. In an example embodiment, a message may be sent from a sending node to one or more receiving nodes requesting the receiving nodes to reduce transmissions on a wireless medium. The sending node and the receiving nodes may be included in a distributed wireless network. In an example embodiment, the wireless medium may be scanned at the sending node to determine whether the one or more receiving nodes are participating in the distributed wireless network by periodically transmitting beacons during a repeated interval, wherein the scanning may be performed periodically, aperiodically, or continuously.

### BACKGROUND

As wireless technology has advanced, a variety of wireless networks have been installed, such as cellular and other wireless networks. Some wireless networks are based upon the Institute of Electrical and Electronics Engineers (IEEE) 802.11 family of Wireless LAN (WLAN) industry specifications, for example. As another example, some wireless networks are based upon the Distributed Medium Access Control (MAC) for Wireless Networks industry specifications of the WiMedia Alliance, for example. For example, the WiMedia network protocol adaptation (WiNet) layer is a protocol adaptation layer (PAL) that builds on a WiMedia ultra-wideband (UWB) common radio platform to augment the convergence platform with TCP/IP services.

An example standard, for example, the Distributed Medium Access Control (MAC) for Wireless Networks of the WiMedia Alliance, defines a distributed medium access control (MAC) sublayer for wireless networks, and further specifies a wireless network structure that does not require an existing infrastructure for communication such as, for example, a WiMedia ultra-wideband (UWB) network. A number of working groups are working to improve on this technology.

Categories of example applications considered for such an example standard may include portable electronic devices intended to be carried by a user, home electronics equipment, and personal computers and peripherals. Example portable electronic devices may have specific requirements to support mobility and good power efficiency. Devices such as home electronics and computers may not be as mobile, and not as sensitive to power efficiency as such portable electronic devices. All of these devices may benefit from a zero-infrastructure environment.

An interval, for example, a periodic time interval may be used to coordinate frame transmissions between devices, for example, a superframe interval may be used which includes a beacon period followed by a data period. The beacon period may include multiple beacon slots which may be used by multiple devices to send beacons.

In an example network formed with fully distributed medium access coordination, logical groups may be formed around each device in the network to facilitate contention-free frame exchanges while exploring medium reuse over different spatial regions. These logical groups may include, for example, a beacon group and an extended beacon group, both of which may be determined with respect to an individual device. For example, a beacon group may include a set of devices from which a device receives beacons that identify the same beacon period start time (BPST) as the device. An extended beacon group may include a union of a device's beacon group and the beacon groups of all devices in the device's beacon group.

Example MAC protocol techniques may attempt to ensure that no member of an extended beacon group transmits a beacon frame at the same time as the device. Information included in beacon frames may facilitate contention-free frame exchanges by ensuring that a device does not transmit frames while a neighbor of the device (e.g., another device in the device's beacon group) is transmitting or receiving frames.

When a device is enabled, it may scan one or more channels for beacons and select a communications channel. If no beacons are detected in the selected channel, the device may create its own beacon period (BP) by sending a beacon. If one or more beacons are detected in the selected channel, the device may synchronize its BP to existing beacons in the selected channel. The device may then exchange data with members of its beacon group using the same channel the device selected for beacons.

Each device may protect its and its neighbors' BPs for exclusive use of the beacon protocol. Thus, no transmissions other than beacons may be attempted during the BP of any device. A device may protect an alien BP, detected by reception of a beacon frame unaligned with the device's own BP, by announcing a reservation covering the alien BP in its beacon. Within the context of a particular beacon group, an alien beacon group may include one or more devices included in a beacon group that identify a beacon period start time (BPST) that is different from the particular beacon group.

An example WiMedia standard also defines a dynamic beaconing technique, which enables devices in a distributed network to maintain fast connectivity. Devices may maintain synchronization with each other by participating in a beacon period, for example, by each device sending its own beacon and listening to other devices' beacons once in each superframe (e.g., 65536 microseconds). The rest of the time the devices may send data to each other or hibernate, or sleep.

If a group of devices moves into the range of another group of devices, the groups may need to synchronize to each other before connectivity from one group to another may be available for the devices, and before channel time reservations may be handled without collisions. A group of devices may thus be viewed as “one device” or “two or more devices participating in the same beacon group,” for example, devices having the same beacon period start time (BPST).

Emissions of transmitting devices operating, for example, in unlicensed bands or in some licensed bands, may be dangerous for the correct operation of some electronic devices. Examples of such sensitive electronic devices may include air traffic control systems, medical appliances, etc.

### SUMMARY

Various embodiments are described relating to communicating with nodes in a wireless network to reduce transmissions of the nodes.

According to an example embodiment, a message may be sent from a sending node to one or more receiving nodes requesting the receiving nodes to reduce transmissions on a wireless medium, wherein the sending node and the receiving nodes are included in a distributed wireless network. According to an example embodiment, the sending the message requesting the receiving nodes to reduce transmissions may include sending a beacon frame in one or more signaling slots included in a superframe. According to an example embodiment, the wireless medium may be scanned at the sending node to determine whether the one or more receiving nodes are participating in the distributed wireless network by periodically transmitting beacons during a repeated interval, wherein the scanning may be performed periodically, aperiodically, or continuously.

In an example embodiment, a message may be sent from a sending node to one or more receiving nodes alerting the receiving nodes that the receiving nodes are approaching an area in which the receiving nodes are instructed to reduce transmissions on a wireless medium, wherein the sending node and the receiving nodes are included in a distributed wireless network. According to an example embodiment, the sending the message alerting the receiving nodes may include sending a beacon frame in one or more signaling slots included in a superframe, wherein the beacon frame includes an indicator of one or more of a warn all operation, including at least one of the receiving nodes determining preparations for revising transmissions or signaling methods indicated by the beacon frame or for residual effects of entry into the area; or a warn device operation, including at least one of the receiving nodes determining whether a device address included in the emergency information element matches an address of the at least one of the receiving nodes, and determining preparations for revising transmissions or signaling methods indicated by the beacon frame or for residual effects of entry into the area it is determined that the device address matches: the address of the at least one of the receiving nodes. According to an example embodiment, the wireless medium may be scanned at the sending node to determine whether the one or more receiving nodes are approaching the area, wherein the scanning may be performed periodically, aperiodically, or continuously.

In another example embodiment, a request may be received from a sending node at a receiving node requesting the receiving node to reduce transmissions on a wireless medium, wherein the sending node and the receiving node are included in a distributed wireless network. According to an example embodiment, the receiving the request requesting the receiving node to reduce transmissions may include receiving a beacon frame in one or more signaling slots included in a superframe. According to an example embodiment, it may be determined whether the request includes a control indicator to control the receiving node to comply with the request.

In another example embodiment, a message may be received from a sending node at a receiving device alerting the receiving device that the receiving device is approaching an area in which the receiving device is instructed to reduce transmissions on a wireless medium, wherein the sending node and the receiving device are included in a distributed wireless network. According to an example embodiment, an alert message may be sent to an application or to a protocol or entity included in the receiving device instructing the application to inform a user, or instructing the protocol or entity of the receiving device to prepare for reducing transmissions on the wireless medium or to move the receiving device away from the area.

In another example embodiment, an apparatus for wireless communications may include a controller, a memory coupled to the controller, and a wireless transceiver coupled to the controller. The apparatus may be adapted to send a message via the wireless transceiver requesting any of one or more devices receiving the message to reduce transmissions on a wireless medium, wherein the apparatus and the any of one or more devices are included in a distributed wireless network. According to an example embodiment, the message may include a beacon frame transmitted in one or more signaling slots included in a superframe, the beacon frame including an emergency information element indicating information associated with the request to reduce transmissions.

In another example embodiment, an apparatus for wireless communications may include a controller, a memory coupled to the controller, and a wireless transceiver coupled to the controller. The apparatus may be adapted to receive a request via the wireless transceiver requesting the apparatus to reduce transmissions on a wireless medium, wherein a device transmitting the message and the apparatus are included in a distributed wireless network.

In another example embodiment, a computer program product for wireless communications may be tangibly embodied on a computer-readable medium and may include executable code that, when executed, may be configured to cause one or more processors to send a message from a sending node to one or more receiving nodes requesting the receiving nodes to reduce transmissions on a wireless medium, wherein the sending node and the receiving nodes are included in a distributed wireless network.

In another example embodiment, a computer program product for wireless communications may be tangibly embodied on a computer-readable medium and may include executable code that, when executed, may be configured to cause one or more processors to receive a request from a sending node at a receiving node requesting the receiving node to reduce transmissions on a wireless medium; wherein the sending node and the receiving node are included in a distributed wireless network.

In yet another example embodiment, a communications signal may be embodied in a wireless communications medium comprising a beacon message including an emergency information element indicating information associated with a request to reduce transmissions.

### BRIEF DESCRIPTION OF THE DRAWINGS

FIGS. 1a-1b are diagrams of example configurations of beacon groups of a wireless network according to an example embodiment.

FIG. 2 is a flow chart illustrating operation of a wireless node according to an example embodiment.

FIG. 3 is a flow chart illustrating operation of a wireless node according to an example embodiment.

FIG. 4 is a flow chart illustrating operation of a wireless node according to an example embodiment.

FIG. 5 is a flow chart illustrating operation of a wireless node according to an example embodiment.

FIGS. 6a-6b is a diagram illustrating operation of transmission of superframes on a medium in a wireless network according to an example embodiment.

FIG. 7 is an example format of a beacon frame payload according to an example embodiment.

FIG. 8 is an example format of an information element included in an example beacon according to an example embodiment.

FIG. 9 is an example format of an emergency information element according to an example embodiment.

FIG. 10 is an example format of an information field included in an emergency information element included in an example beacon according to an example embodiment.

FIG. 11 is a flow chart illustrating operation of a wireless node sending a message according to an example embodiment.

FIG. 12 is a flow chart illustrating operation of a wireless node receiving a message according to an example embodiment.

FIG. 13 is a block diagram illustrating an apparatus that may be provided in a wireless station according to an example embodiment.

### DETAILED DESCRIPTION

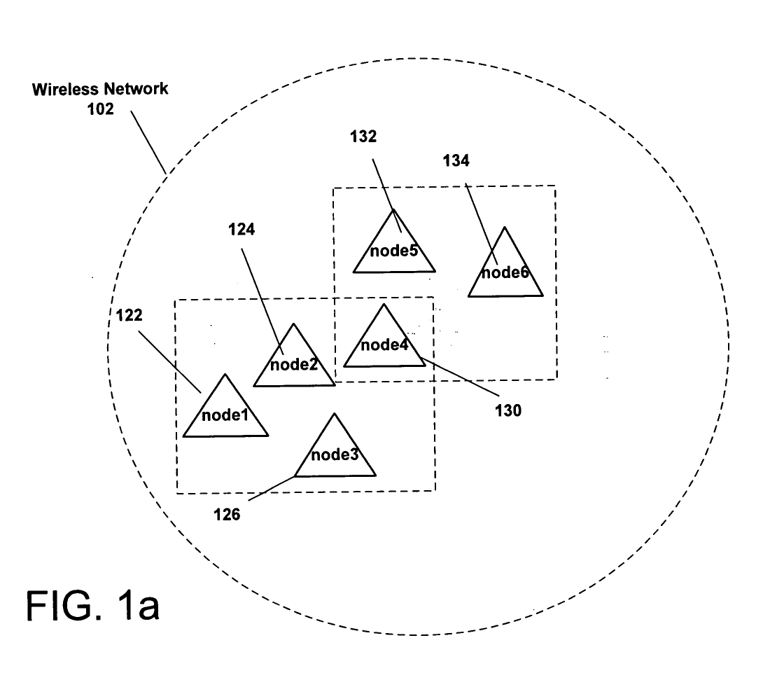

Referring to the Figures in which like numerals indicate like elements, FIGS. 1a-1b are diagrams of example configurations of beacon groups of a wireless network 102 according to an example embodiment. The term “node” or “wireless node” or “network node” or “network station” may refer, for example, to a wireless station, e.g., a subscriber station or mobile station, an access point or base station, a relay station or other intermediate wireless node, or other wireless computing devices, such as laptop computers, desktop computers, and peripheral devices, as examples.

As shown in FIG. 1a, a wireless network node node1 122 is in range of, and thus may receive messages from, nodes node2 124, node3 126, and node4 130. Moreover, a node5 132 and node6 134 are also in range of, and may receive messages from, the node4 130. Further, each of node2 124, node3 126, and node4 130 are in range of each other, and may receive messages from among themselves. Thus, for example, node1 122, node2 124, node3 126, and node4 130 may be included in a common beacon group. However, node1 122 and node node5 132, as shown in FIG. 1a, are not in range of each other, and thus may not receive messages from each other directly. Thus, for example, the node node4 130 may send messages to, or receive messages from, any of the nodes node1 122, node2 124, node3 126, node5 132, and node6 134. Thus, node4 130, node5 132, and node6 134 may also be included in a common beacon group. For example, node4 130, node5 132, and node6 134 may be included in the same beacon group as node1 122, node2 124, node3 126, and node4 130, for example, an extended beacon group, for example, according to WiMedia protocol.

As shown in FIG. 1b, the wireless network node node6 134 is in range of, and thus may receive messages from, node7 140, node8 142, and node9 144. However, the nodes node7 140, node8 142, and node9 144 may be included in a different beacon group from the beacon group of node6 134, and thus may be referred to as being part of an alien beacon group. Messages sent by node7 140, node8 142, and node9 144 may interfere with reception and transmission by node6 134, and thus node6 134 may determine the beacon period (BP) and the beacon period start time (BPST) of the alien beacon group, and may reserve a portion of the medium for the transmissions of node7 140, node8 142, and node9 144 in order to avoid collisions.

If, for example, any of nodes node7 140, node8 142, and node9 144 were to move within the operating range of node6 134, then any of the affected nodes may change their beacon group according to WiMedia protocol. One skilled in the art of wireless communications would understand that nodes may change beacon groups for many different reasons.

Emissions of transmitting devices operating in unlicensed bands, and sometimes also in licensed bands, may be dangerous for the correct operation of some electronic devices. Examples of such sensitive electronic devices may include air traffic control systems, medical appliances, etc. Emitting devices, for example, transceivers, may avoid interference with other communication systems by timing avoidance or by changing channels. However, a sensitive device may include equipment that is sensitive to interference in one or more frequency bands, and that is not a communication device. Further, a separate guard device may be located in the vicinity of the sensitive device that may sense the interference and may communicate with the transmitting devices. A transmitting device may thus be dangerous unless proper measures are taken to avoid interference with the sensitive device.

Generally, energy emission limits may be set by regulatory boards to limit detrimental effects of transmitters and electronic devices. Restrictions may be defined in terms of emission of a single emitting device. However, more devices may operate in unlicensed bands in the same coverage area, thus increasing the total interference energy impacting a potentially sensitive electronic device operating in the same area. Moreover, a transmitting/emitting device designed to comply with such regulations may, e.g., due to malfunction or damage, emit energy above and/or outside the legal energy emission limits.

Short range communications (SRC) systems such as wireless personal area networks (WPAN) may operate at times in unlicensed bands, for example using ultrawide-band (UWB) signals, which make use of a large portion of the entire spectrum. Thus, these systems may be dangerous to a broader range of electronic devices. The discussion herein may extend to any transmitting radio device and to narrow-band transmitting devices.

A short range communication system, for example, a sensor network, may be related to the functionalities of a sensitive appliance and work in cooperation with the sensitive device, and thus, not all short range communication devices in the neighborhood of a sensitive device may be considered as potentially dangerous. Moreover, not all frequency bands or signaling methods used by devices in the neighborhood of the sensitive device may be equally potentially harmful.

A sensitive electronic device may be equipped with a transceiver (TRX) device, which may, for example, be part of the sensitive electronic device, or may be located on a guard device separated from the sensitive electronic device. The TRX may normally operate only in reception mode to scan the surroundings for detection of networks operating in the area. If such a network is detected, and if the received energy from one or more devices of the network is determined to potentially interfere with the operations of the sensitive device, the TRX may block transmissions of one or all devices of that network. The TRX may, for example, limit the blocking to selected frequency bands and/or signaling methods. An example TRX may be embedded in the same shell as that of the device which is to be protected. Similar operations may be performed by similar devices located in appropriate locations, which may not necessarily be in proximity with sensitive devices. For example, such devices may be located at entrances to sensitive areas.

The example techniques discussed herein may include operations on distributed networks using multiple frequency bands and/or signaling methods. These example techniques may minimize or eliminate problems of unreliability and/or malfunctioning of critical appliances (e.g., military, air traffic control, medical, etc.) due to dangerous emissions of neighbor devices operating in unlicensed or licensed bandwidths.

A node10 146 may, for example, include a device that is sensitive to certain transmissions of other devices, or that is configured to detect transmissions of devices that should not be transmitting in particular channels or frequency bands, or should not be using particular signaling methods. For example, node10 146 may include a device located in a hospital or on an airplane that may malfunction if other transmissions interfere with the critical operations of the device. For example, the device may include a life support device such as a pacemaker, which may malfunction if particular transmissions interfere with its operation. As another example, the node10 146 may be located in a theater, church, or other location where, for example, patrons are not allowed to use their mobile telephones or other distracting devices during performances or services.

As discussed below, nodes that transmit interfering signals may be silenced, or the interfering transmissions may be reduced by sending a request to the transmitting nodes to reduce their transmissions.

As discussed previously, electronic equipment may be sensitive to interference from radio signals. For this reason, a sensitive electronic device may be equipped with one or more interfaces to a selected system. Further, a separate guard device may be located near the sensitive electronic equipment to communicate with interfering nodes, for example, because signals sent by the guard device itself may cause unacceptable interference with the sensitive electronic equipment. The selected systems may include, e.g., SRC systems, for example, WiMedia/MBOA distributed networks, IEEE802.15.3 or IEEE802.15.4 centralized networks, and Bluetooth. Example techniques discussed herein may be extended to a number of networks operating in unlicensed and/or licensed bands whenever emissions may endanger a sensitive electronic device. One skilled in the art of communications will understand that other systems may similarly use the example techniques described herein.

The sensitive electronic device may, for example, initiate a silencing operation as discussed below. Targets of the silencing operation may include emitting devices in the neighborhood or area of the sensitive electronic device. The interfering devices active in the neighborhood or area may belong to more networks (sometimes referred to as piconets) or may be based on different technologies. However, even within the same technology, a number of frequency bands may be used, simultaneously or not, by the same transceiver. As noted, not all utilized frequency bands or signaling methods may be equally potentially harmful. The operations described below may thus be restricted to a selected subset of those frequency bands and/or signaling methods.

Example functionalities described herein with regard to sensitive devices may also be applicable to devices having just the silencing functionalities embedded. Such devices may be used in lieu of, or together with, warning signs that recommend that users switch off particular categories of electronic devices, and thus, safety may be enforced.

An example sensitive device may regularly scan all target systems and channels to determine potential dangerous devices. This scanning operation may be repeated periodically, aperiodically, or the scanning may be performed continuously. The sensitive device may send an emergency beacon frame (e.g., an EM-FRAME) in proper logical channels of the target system, in order to reach the potentially dangerous devices. These logical channels may include all possible signaling channels. For some systems, these logical channels may include, for example, all free beacon slots, including possible signaling slots or emergency slots left available for particular uses such as emergencies. For example, in an example WiMedia MAC protocol, two signaling slots may be left available at the beginning of a superframe.

The sensitive device or an associated guard device may decide to silence all potentially dangerous transmissions in the area, e.g., those transmissions using frequency bands and/or signaling methods considered as potentially harmful to a sensitive device. However, in order to limit the number of interfering devices active in the area, but without completely stopping completely their operations, the sensitive device may decide to set them in hibernation. The hibernation cycle(s) may thus be selected by the sensitive device and associated request or command messages may be sent to the interfering devices/networks.

For some reasons other than safety, e.g., for energy saving, some systems may include hibernation functionalities, wherein a hibernating device may remain inactive for a given time without losing its association with other devices that are included in the hibernating device's group. If the hibernating functionality is available, it may be employed by the sensitive device to reduce the transmissions of a device emitting potentially dangerous signals.

After issuing a silencing command, for example, a “Stop” command, a sensitive device may periodically scan the channels in order to determine potential new networks (sometimes referred to as piconets or beacon groups) after transmissions of one or more previous network devices have been stopped or reduced. Thus, even if a stopped device were to restart, the new network/piconet/beacon group may be detected by the sensitive device. For example, in the context of WiMedia networks, the periodic scanning may be performed with a period of at most mMaxLostBeacons.

Since both Stopping and Pausing (e.g., Hibernation) may imply interruption of operations of the potentially dangerous device, a Warning signal may be sent to transmitting devices outside the sensitive area to warn that a sensitive area is close and to allow users to complete their ongoing tasks before proceeding into the protected area. Such warning signals may, for example, be sent by devices placed at doors.

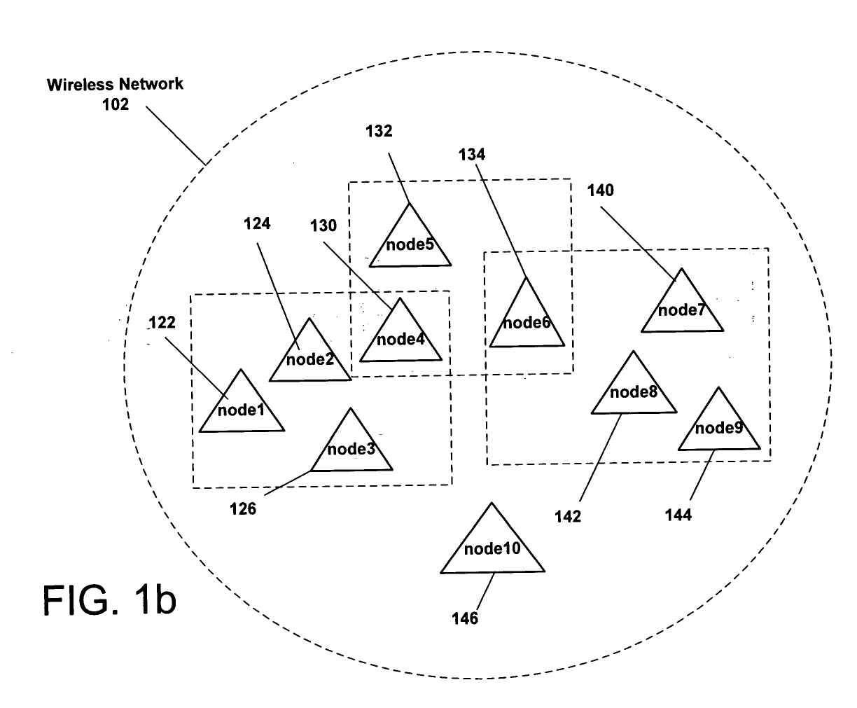

FIG. 2 is a flow chart illustrating operation of reducing transmissions of nodes of a wireless network according to an example embodiment. A message may be sent from a sending node to one or more receiving nodes requesting the receiving nodes to reduce transmissions on a wireless medium, wherein the sending node and the receiving nodes are included in a distributed wireless network (210). For example, node4 130 may send a message to node2 124 requesting that node2 124 reduce transmissions on a wireless medium. According to an example embodiment, control of the distributed wireless network may be substantially equally distributed among the sending node and each of the one or more receiving nodes.

According to an example embodiment, a beacon frame may be sent in one or more signaling slots included in a superframe (212). According to another example embodiment, the beacon frame may be sent in a beacon slot reserved for the sending node, for example, to increase a probability that the receiving nodes will receive the beacon frame.

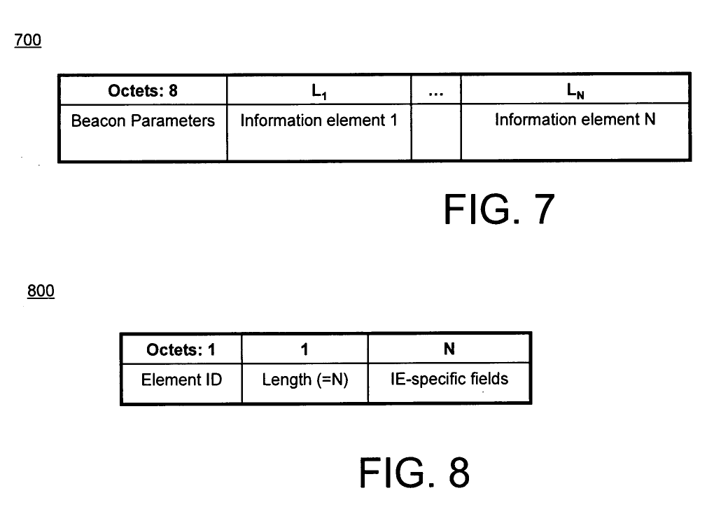

According to an example embodiment, a beacon frame may be sent including an emergency information element in one or more signaling slots included in a superframe (214). For example, the emergency information element may include an indicator of a critical level associated with the sending node. For example, node4 130 may send a beacon including an emergency information element as discussed below with regard to FIG. 9 to node2 124, including an indicator of a critical level associated with node4 130. Nodes receiving the information element may then determine, for example, whether a critical level of the receiving node indicates a priority level less than a priority level associated with the critical level associated with the sending node.

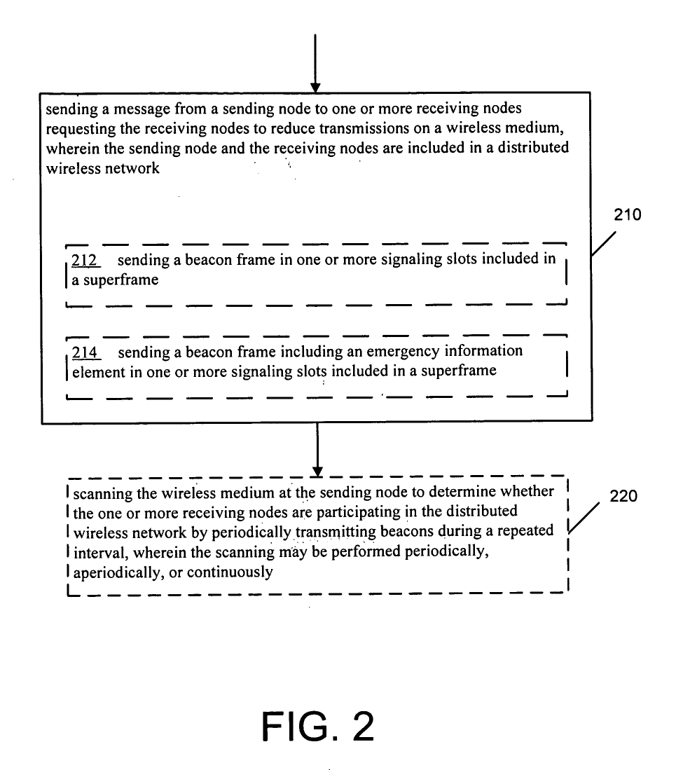

FIG. 3 is a flow chart illustrating operation of alerting receiving nodes that the receiving nodes are approaching an area in which the receiving nodes are instructed to reduce transmissions on a wireless medium according to an example embodiment. At 310, a message may be sent from a sending node to one or more receiving nodes alerting the receiving nodes that the receiving nodes are approaching an area in which the receiving nodes are instructed to reduce transmissions on a wireless medium, wherein the sending node and the receiving nodes are included in a distributed wireless network. According to an example embodiment, control of the distributed wireless network may be substantially equally distributed among the sending node and each of the one or more receiving nodes.

According to an example embodiment, a beacon frame may be sent in one or more signaling slots included in a superframe. The beacon frame may include an indicator of one or more of a warn all operation, including at least one of the receiving nodes determining preparations for revising transmissions or signaling methods indicated by the beacon frame or for residual effects of entry into the area; or a warn device operation, including at least one of the receiving nodes determining whether a device address included in the emergency information element matches an address of the at least one of the receiving nodes, and determining preparations for revising transmissions or signaling methods indicated by the beacon frame or for residual effects of entry into the area it is determined that the device address matches the address of the at least one of the receiving nodes (312).

According to an example embodiment, the wireless medium may be scanned at the sending node to determine whether the one or more receiving nodes are participating in the distributed wireless network by periodically transmitting beacons during a repeated interval, wherein the scanning may be performed periodically, aperiodically, or continuously (320). For example, node4 130 may scan the wireless medium to determine whether node2 124 is participating in the distributed wireless network by periodically transmitting beacons during a repeated interval.

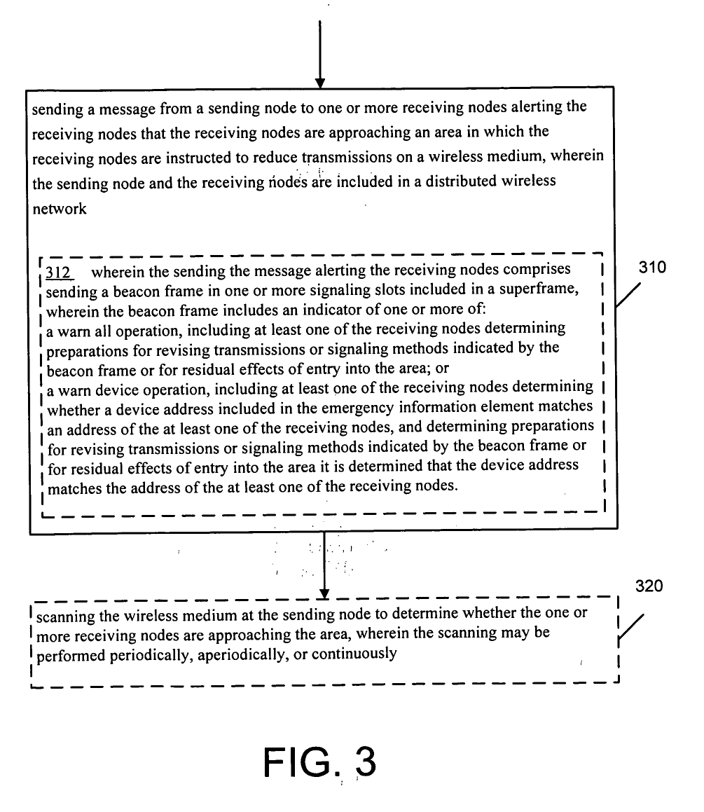

FIG. 4 is a flow chart illustrating operation of a wireless node according to an example embodiment. At 410, a request may be received from a sending node at a receiving node requesting the receiving node to reduce transmissions on a wireless medium, wherein the sending node and the receiving node are included in a distributed wireless network. For example, a beacon frame may be received in one or more signaling slots included in a superframe (412).

According to an example embodiment, it may be determined whether the request includes a control indicator to control the receiving node to comply with the request (420). For example, it may be determined whether the receiving node includes a critical level having a lower priority than a critical level included in the request (422).

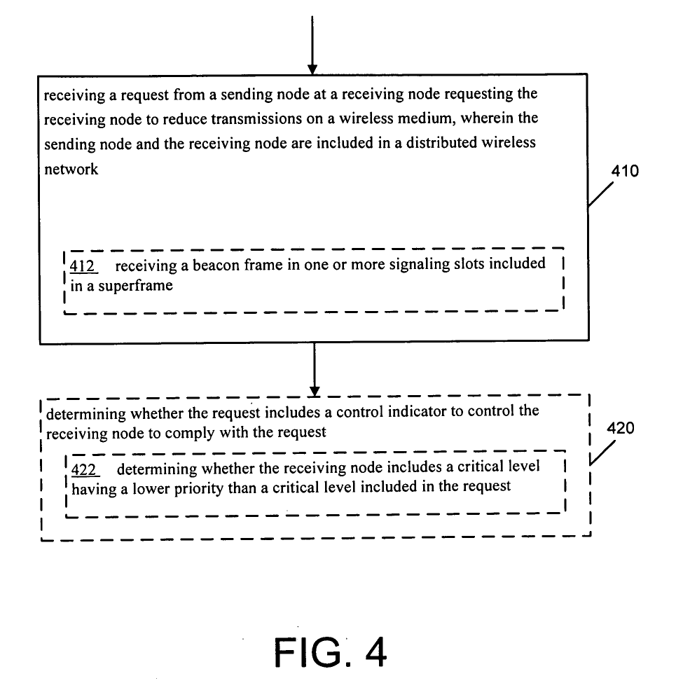

FIG. 5 is a flow chart illustrating operation of a wireless node according to an example embodiment. At 510, a message may be received from a sending node at a receiving device alerting the receiving device that the receiving device is approaching an area in which the receiving device is instructed to reduce transmissions on a wireless medium, wherein the sending node and the receiving device are included in a distributed wireless network.

According to an example embodiment, an alert message may be sent to an application or to a protocol or entity included in the receiving device instructing the application to inform a user, or instructing the protocol or entity of the receiving device to prepare for reducing transmissions on the wireless medium or to move the receiving device away from the area (520). For example, the MAC may inform an application or an upper layer protocol to perform appropriate operations.

In some communication networks, time may be divided into a sequence of intervals with similar timing structure. In an example WiMedia network, a basic timing structure for frame exchange may include a superframe. Such a WiMedia network may include a distributedly controlled wireless communications network in which nodes or devices included in the network periodically transmit beacon transmissions during a repeated time interval, wherein control of a communications resource is shared between devices belonging to the wireless communications network. For example, in a WiMedia ultra-wideband (UWB) environment, devices or nodes included in the WiMedia network may be considered as equal (e.g., control of the distributed wireless network is substantially equally distributed among the devices or nodes included in the distributed wireless network), and there may be no active connection between the devices or nodes.

Other examples may include short range communication systems or ultra-wide band systems. Examples standards may include WiMedia/MBOA, IEEE802.15.3, IEEE802.15.4, and Bluetooth.

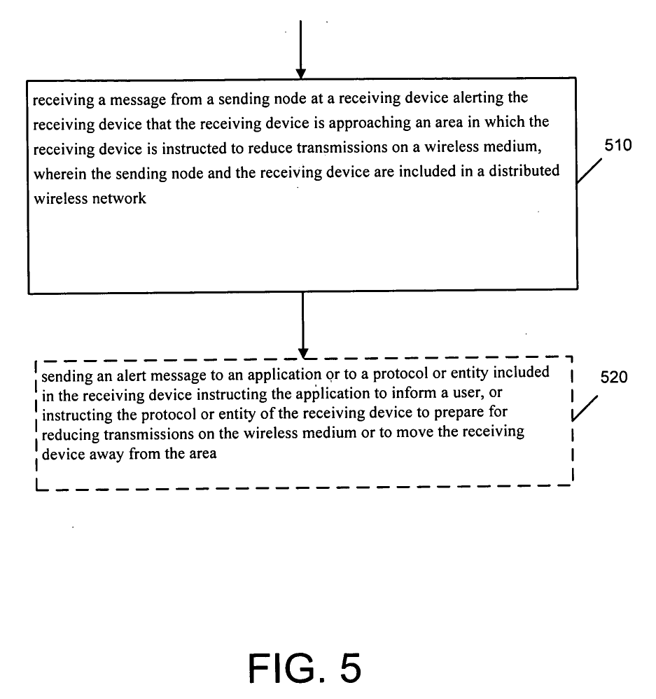

FIGS. 6a-6b depict operations of transmission of superframes on a medium in a wireless network according to an example embodiment. For example, a duration of an example superframe N 602 may be specified as mSuperframeLength. The superframe N 602 may include a start timing 604 which may be referred to as a beacon period start time (BPST).

The superframe may include multiple medium access slots (MASs) 608, wherein each MAS duration may have a length of mMASLength. In the example of FIG. 6a, the superframe N 602 is shown as including of 256 medium access slots (MASs) 608, although any desired number of MASs may be included in a superframe generally.

Each superframe may start with a beacon period (BP), which may extend over one or more contiguous MASs, which may be referred to as beacon slots 606. The start of the first MAS in the BP, and the superframe, may thus be the beacon period start time (BPST).

According to an example embodiment, each superframe 602 may start with a BP, which may include a maximum length of mMaxBPLength beacon slots 610. The first mSignalSlotCount beacon slots of a BP may be referred to as signaling slots 612 and may be used to extend the BP length of neighbors. For example, the first two beacon slots may be referred to as signaling slots, and may be reserved for specific purposes, such as for beacons indicating an emergency, or beacons indicating a beacon period length. Thus, all active nodes or devices may be required to listen to transmissions in the signaling slots.

An active mode device may, for example, transmit a beacon in the BP and listen for neighbor's beacons in all beacon slots specified by its BP length in each superframe 602. When transmitting in a beacon slot 606, a device may start transmission of the frame on the medium at the beginning of that beacon slot 606. A device may announce its BP length, for example, measured in beacon slots, in its beacon. The announced BP length may include the device's own beacon slot and all unavailable beacon slots in the BP of the prior superframe. The announced BP length may not include more than mBPExtension beacon slots after the last unavailable beacon slot in the BP of the prior superframe. The announced BP length may not exceed mMaxBPLength 610. According to an example embodiment, power-sensitive devices may not include any beacon slots after the last unavailable beacon slot in their announced BP length.

The BP length reported by a device may vary, as new devices may become members of its extended beacon group, and as the device or other devices in its extended beacon group select a new beacon slot for beacon collision resolution or BP contraction.

According to an example embodiment, before a device transmits any frames, it may scan for beacons for at least one superframe. If the device receives no beacon frame headers during the scan, it may create a new BP and send a beacon in the first beacon slot after the signaling slots. If the device receives one or more beacon headers, but no beacon frames with a valid frame check sequence (FCS) during the scan, the device may scan for an additional superframe.

If the device receives one or more beacons during the scan, it may not create a new BP. Instead, prior to communicating with another device, the device may transmit a beacon in a beacon slot chosen from up to mBPExtension beacon slots located after the highest-numbered unavailable beacon slot it observed in the last superframe and within mMaxBPLength after the BPST. For example, as shown in FIG. 6b, beacon slot 614 may be the highest-numbered unavailable beacon slot observed by DEV 8 in the last superframe.

According to an example embodiment, if a node or device detects a beacon collision, the node or device may select a different beacon slot for its subsequent beacon transmissions, for example, from up to mBPExtension beacon slots located after the highest-numbered unavailable beacon slot it observed in the last superframe and within mMaxBPLength after the BPST. If the beacon slot selected for its beacon transmission is located beyond the BP length of any of its neighbors, for example, the node or device may also transmit the same beacon, except with a Signaling Slot bit set to one, or some other indicator, in a randomly chosen signaling beacon slot in the BP.

According to an example embodiment, due to changes in a propagation environment, mobility, or other effects, devices using two or more unaligned BPSTs may come into range, which may cause overlapping superframes. A received beacon, with a valid header check sequence (HCS) and frame check sequence (FCS), for example, that indicates a BPST that is not aligned with a device's own BPST may be referred to as an alien beacon. For example, a BP defined by the BPST and BP length of an alien beacon may be referred to as an alien BP.

Synchronization problems, for example, may cause a beacon of a fast device to appear to be an alien beacon. Thus, according to an example embodiment, a device may consider a BPST to be aligned with its own if that BPST differs from its own by less than 2xmGuardTime. A device may consider an alien BP to overlap the device's own BP if its BPST falls within the alien BP or if the alien BPST falls within its own BP.

According to an example embodiment, the medium may generally be accessed in one of three ways: 1) during the BP, devices may send only beacon frames; 2) during a reservation, devices participating in the reservation may send frames according to rules associated with a device reservation protocol (DRP), as discussed below; or 3) outside the BP and reservations, devices may send frames using a prioritized contention based access (PCA) technique.

The protocols and facilities of an example embodiment may be supported, for example, by an exchange of information between devices. Information may, for example, be broadcast in beacon frames or may be requested, for example, in Probe commands. For each type of information, an Information Element (IE) may be defined. IEs may be included by a device, for example, in its beacon at any time or may be requested or provided using an example Probe command.

An effective example technique to extend battery life of battery powered devices may enable devices to turn off completely or reduce power for long periods of time, where a period of time may be considered to be long relative to the duration of a superframe. Examples of power management modes in which a device can operate include an active state and a hibernation state. Devices in active mode may transmit and receive beacons in every superframe. Devices in hibernation mode may hibernate for multiple superframes and may not transmit or receive in those superframes. Additionally, devices may sleep for portions of each superframe in order to save power.

To coordinate with neighbors, a device may, for example, indicate its intention to hibernate by including a Hibernation Mode IE in its beacon. The Hibernation Mode IE may specify the number of superframes in which the device will sleep and will not send or receive beacons or any other frames.

An example period of time in which a device is in active mode and may be ready to exchange frames with its neighbors may be referred to as a local active period (LAP). A number of superframes between the start of two consecutive local active periods (LAPs) may then be referred to as an active cycle. The periodicity of going into active mode (i.e., the active cycle), may be decided by the device depending on its incoming/outgoing traffic and power consumption needs. A device may choose the value of its active cycle according to an example formula such as:

Active cycle=2n,

where n is an active cycle index; n=0, 1, 2, . . . , wMaxActiveCycleIndex.

An example value of wMaxActiveCycleIndex may be determined from an example WiMedia MAC maximum hibernation time. An example wMaxActiveCycleIndex may be set to 8, thus indicating a maximum active cycle of 256, which may be compatible with a maximum hibernation period of 255 superframes indicated by an example WiMedia MAC, since devices may be active for at least one superframe every LAP.

According to an example embodiment, an example Active Cycle Start Countdown (ACSC) may be set to the number of superframes remaining before the device's Active Cycle Start Time (ACST), when it may start a new active cycle. If the ACSC field is zero, the device may start a new active cycle in the next superframe.

A device may set an Active Cycle Index field in an example WiNet Identification IE to a current active cycle index associated with the device. The device may indicate that it never hibernates by setting the Active Cycle Index field to zero.

The duration of a LAP may be dynamic, and may be determined using a timeout policy. A device may end its LAP if there is no traffic buffered for any of its active neighbors and no traffic pending for it from active neighbors as indicated by an example TIM IE. To terminate a LAP, a device may announce in one or more beacons that it will enter hibernation mode via a Hibernation Mode IE.

In order to synchronize with neighbors' LAPs, a device may maintain an ACST for its beacon group. The device may set the Active Cycle Start Countdown (ACSC) field in a WiNet Identification IE for the device to the number of superframes before the start of the next active cycle, not including the current superframe. A new active cycle may be started every 2wMaxActiveCycleIndex superframes. The ACSC value may be (2wMaxActiveCycleIndex-1) in the first superframe of every active cycle and may be decremented by 1 in every subsequent superframe. A value of zero may thus indicate that a new active cycle will start at the end of the current superframe.

When a device joins a beacon group, it may set its ACSC such that it matches the ACSC included in a beacon of one or more neighbors. If the device does not receive any beacon with a WiNet Identification IE, the device may create a new ACSC.

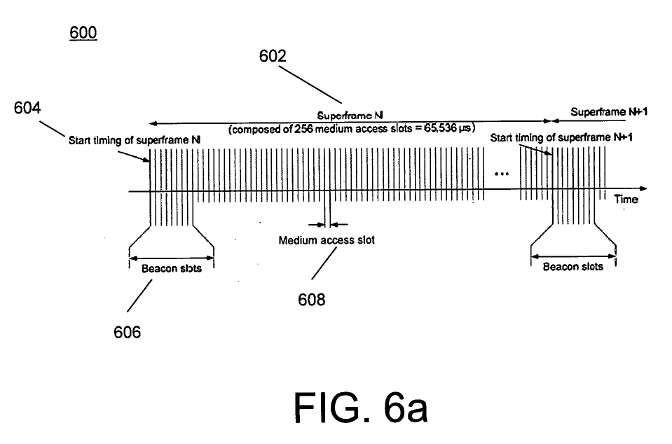

FIG. 7 is an example format of an example beacon frame payload 700 that may be included in a beacon according to an example embodiment. The example beacon frame payload 700 may include beacon parameters and one or more information elements. According to an example embodiment, the beacon frame payload 700 may include an example WiNet beacon frame payload.

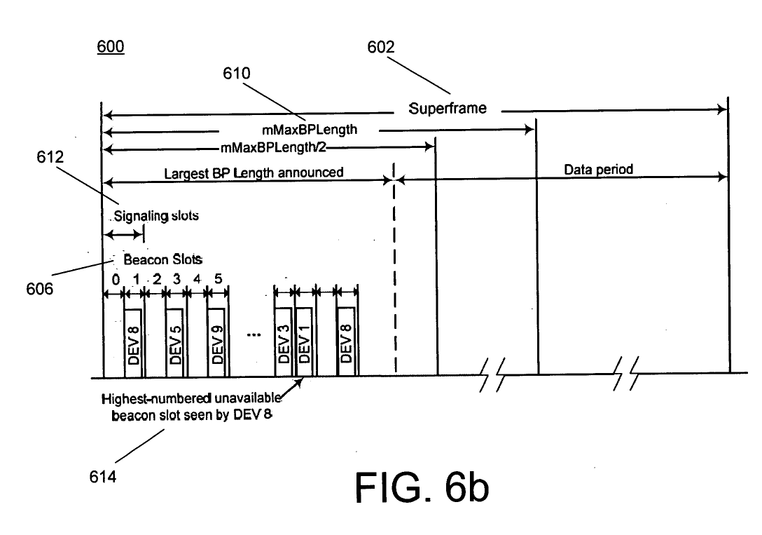

FIG. 8 is an example format of an information element 800 included in an example beacon according to an example embodiment. According to an example embodiment, the information element 800 may include a WiNet information element.

FIG. 9 is an example format of an emergency information element 900 according to an example embodiment. For example, the emergency information element 900 may include an element identifier, indicating that the information element includes an emergency information element. According to an example embodiment, the emergency information element 900 may include a flag to indicate the emergency type of the frame (e.g., an EM-FRAME) that includes the emergency information element 900.

According to an example embodiment, the emergency information element 900 may include a device address (e.g., a DevAddr field). The DevAddr field may be set, for example, to an address of a specific device or network, to the address of a multicast group, or to a broadcast address. For example, two octets may be sufficient for handling these example addresses.

According to an example embodiment, the emergency information element 900 may include a hibernation duration indicator (e.g., an EM-HIB field). For example, the hibernation duration indicator may be expressed as an exponent of base two, wherein the resulting value indicates a number of superframes of a time axis into which the interfering device or system is divided. For example, an octet may be sufficient for identifying a hibernation duration value.

According to an example embodiment, the emergency information element 900 may be included, for example, in a beacon message, which may be included in a communications signal embodied in a wireless communications medium.

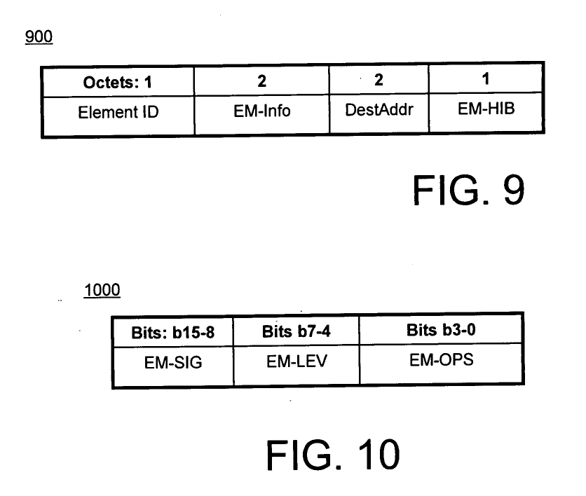

FIG. 10 is an example format of an information field 1000 included in an emergency information element 900 included in an example beacon according to an example embodiment. According to an example embodiment, the emergency information field 1000 may include an identification of a critical level (e.g., an EM-LEV) of a service operated by a sensitive device that may be sending the emergency information element 900. Examples of such critical levels may include one or more of the following: 0=military; 1=air traffic control; 2=medical; 3=emergency and police; . . . ; n=consumer electronics. The EM-LEV field may include a value, for example, two to four bits in length.

According to an example embodiment, the information field 1000 may include an identification of example operations (e.g., EM-OPS) requested of the receiving network or device, which may be interfering with the sensitive device. The length of the EM-OPS field may be related to the number of possible commands or operations that may be requested of the receiving network or device. For example, if ten commands are defined, then four bits may be used to identify which operation is requested.

According to an example embodiment, the information field 1000 may include an identification of the frequency bands and/or signaling methods (e.g., an EM-SIG field) for which the operations identified by the EM-OPS field apply. The length of the EM-SIG field may thus be related to the number of frequency bands and/or signaling methods involved in the request. For example, an octet may be sufficient for identifying several frequency bands and/or signaling methods. If an example EM-SIG field is available, the sending device may use the EM-SIG field to specify the frequency bands and/or signaling methods to which the requested operation refers, thus minimizing any decrease in grade of service in the devices' that may become targets of the requested operation specified by the EM-OPS field.

A device of a short range communications (SRC) network may be associated with a critical level (e.g., an EM-LEV) that may be known to the device. Upon reception of a beacon including an emergency information element (e.g., an EM-FRAME), a device having an EM-LEV (e.g., DEV.EM-LEV), may compare the EM-LEV in the EM-FRAME (EM-FRAME.EM-LEV) with its own EM-LEV. If the device's EM-FRAME.EM-LEV is, for example, smaller that DEV.EM-LEV (e.g., if the receiving device is associated with a lower priority than a priority indicated in the EM-LEV of the sending device), the receiving node or device may be instructed to comply with the commands. Otherwise, the receiving node or device may ignore the commands (or obey them, depending on decisions made locally to the receiving node or device). If the receiving device is not associated with an EM-LEV, it may be instructed to obey the commands included in the EM-FRAME. A receiving device that is instructed to obey commands, as discussed above, may be referred to as a low critical level device (LC-DEV).

The sending node may issue an example command, indicated by the EM-OPS field, as discussed below. Four possible example operations associated with the example commands may include: an example Hibernation operation, which may last a for predetermined time, an example Pause operation, which may last for an unspecified time (e.g., until a Resume operation), an example Stop operation, which may last indefinitely, and an example Warning operation, for which a command may be sent before one of the previous messages. Decisions regarding which operational command is to be issued may be left to the sending node or device.

Each example command shown below may include an indication whether the command is intended to be obeyed by all low critical level devices that receive the command, or by only those devices whose address may be included in the DEV-ADDR field. For example, if a command indicates “All,” then a receiving node or device that may include a low critical level device (LC-DEV) may be instructed to perform the indicated operation with regard to all transmissions including control and data frames making use of frequency bands and/or signaling methods indicated by the EM-SIG field.

If an optional EM-SIG field is omitted, the receiving node or device may be instructed to perform the indicated operation with regard to all transmissions including control and data frames, on all frequency bands and/or with all signaling methods in use by the receiving node or device. Thus, if a superframe structure is present in the current system, the receiving node or device may be instructed to perform the indicated operation, starting from the current superframe (SF), with regard to the transmissions including beacon, control, and data frames.

As another example, if a command indicates “Dev,” then a receiving node or device that may include a low critical level device (LC-DEV) may determine whether the DevAddr field of the EM-FRAME matches the address of the receiving node or device, or the multicast address of its multicast group or the broadcast address. If a match is determined, the receiving node or device may be instructed to operate as though a similar command indicating “All” were received, as discussed previously.

Example operations that may be indicated as commands by the EM-OPS field may include one or more of:

1. StopAll, wherein a receiving node or device that may include a low critical level device (LC-DEV) may be instructed to stop, immediately, all transmissions including control and data frames making use of frequency bands and/or signaling methods indicated by the EM-SIG field.

2. StopDev, wherein a receiving node or device may determine whether the DevAddr field of the EM-FRAME matches the address of the receiving node or device, or the multicast address of its multicast group or the broadcast address, and may be instructed to operate as though a StopAll command were received. A stopped node or device (i.e., a node or device that has received a Stop command) may not start any new transmission via any frequency bands/signaling methods that have been indicated to be stopped, before a predetermined time. For example, the stopped time may be determined as N*mMaxLostBeacons, with N>=1.

3. PauseAll, wherein a receiving node or device may be instructed to suspend, immediately, all transmissions including control and data frames making use of the frequency bands and/or signaling methods indicated by the EM-SIG field. The receiving node or device may also continue listening to the channel waiting for receipt of a Resume command.

4. PauseDev, wherein a receiving node or device may determine whether the DevAddr field of the EM-FRAME matches the address of the receiving node or device, or the multicast address of its multicast group or the broadcast address, and may be instructed to operate as though a PauseAll command had been received. Thus, a Pause operation followed by a Resume operation may avoid or minimize attempts by a silenced node or device to restart without explicit authorization.

5. ResumeAll, wherein a receiving node or device may resume its transmissions using the frequency bands and/or signaling methods indicated by the EM-SIG field. If an optional field EM-SIG is missing, the receiving node or device may resume its transmissions on all frequency bands and/or with all signaling methods used by that receiving node or device in normal operations. If similar settings are applicable, it may use those settings; otherwise it may start new scanning/association procedures. These settings may include settings needed for coordinated operation of devices. Thus, if a superframe structure is present in the system, and if the superframe includes a beacon period portion, the settings described above may include beacon slot positions, etc.

6. ResumeDev, wherein a receiving node or device may resume its transmissions using the frequency bands and/or signaling methods indicated by the EM-SIG field. If an optional EM-SIG field is missing, the receiving node or device may resume its transmissions on all frequency bands and/or with all signaling methods used by that node or device in normal operations. Settings may be handled as discussed with regard to the ResumeAll operation. The Pause and Resume operations are similar to a hibernation operation, but are intended for use over an indefinite time instead of a predetermined time such as the duration of a hibernation operation. For example, a stopped node or device (i.e., a node or device that has received a Stop command) may be considered as disassociated, whereas a Hibernated node or device (i.e., a node or device that has received a Hibernate command) may be considered as hibernating for a duration indicated by the EM-HIB field.

7. HibernateAll, wherein a receiving node or device may be instructed to go into hibernation, immediately, based on the hibernation duration indicated by the EM-HIB field. If the EM-HIB field indicates the smallest time unit for the system, the HibernateAll may be interpreted as a StopAll command (e.g., in accordance with an example definition of the hibernation duration expressed as an exponent of 2). All receiving nodes or devices receiving the EM-FRAME may interpret the duration indicated in the EM-HIB as though it were announced by all low critical level devices (LC-DEVs) in the same network. Thus, for an example WiMedia MAC specification, each receiving device may behave as though it had received from those other devices a local active period (LAP) information element (IE) with the field set consistently with the EM-HIB field. If a superframe structure is present in the system, the receiving node or device may go into hibernation starting from the current superframe (SF). In some example systems the hibernation duration may be referred to and denoted as a hibernation cycle duration. Moreover, if a superframe structure is present in the system, the smallest time unit for the system may be represented by 1 SF of cycle length.

8. HibernateDev, wherein a receiving node or device may determine whether the DevAddr field of the EM-FRAME matches the address of the receiving node or device, or the multicast address of its multicast group or the broadcast address, and may be instructed to operate as though it had received a HibernateAll command. All nodes or devices receiving the EM-FRAME may interpret the duration indicated in the EM-HIB as though it were announced by the device(s) addressed by the DevAddr field of the EM-FRAME. For example WiMedia MAC devices, each device may behave as though it had received from those addressed devices a LAP IE with the field set consistently with the EM-HIB field.

All the above operations may imply interruption of a user's operations that may be performed by the potentially dangerous device. Therefore, a Warning message may be sent, for example, outside a sensitive area to warn that a sensitive area is close and to allow users to complete their ongoing tasks before proceeding into the protected sensitive area. The warning signals may, for example, be sent by devices placed at doors. For example, a user receiving a warning signal may decide to step backwards and complete one or more tasks before entering the sensitive area. More generally, abrupt interruptions may cause malfunctions such as instability, or undesirable behavior in some systems. Tasks that may require transmissions, for example, may be completed prior to entry into the sensitive area, in order to ensure stable operations in the potentially dangerous devices.

Thus, example warning operations that may be indicated as further commands by the EM-OPS field may include one or more of:

9. WarnAll, wherein a receiving node or device may send to upper layers a message to inform the user or application that the receiving node or device is approaching a sensitive area. If an EM-SIG field is present, the receiving node or device may determine which frequency bands and/or signaling methods will no longer be available. This message may be used at upper layers to complete one or more ongoing operations before encountering abrupt interruptions. The additional information included in the EM-SIG field may also be used by the user/application to estimate a residual grade of service that may be available after entering the sensitive area.

10. WarnDev, wherein a receiving node or device may determine whether the DevAddr field of the EM-FRAME matches the address of the receiving node or device, or the multicast address of its multicast group or the broadcast address. If a match is determined, the receiving node or device may be instructed to operate as though it had received a WarnAll command.

In distinguishing between a Pause command and a Stop command, it is noted that a Pause command may be followed by a Resume command. The sending node or device may thus send a Resume command after a Pause command. For example, a Paused device may wait for a Resume, listening to the channel. If a sending node or device “knows” that is not going to send a Resume command, the sending node or device may send a Stop command instead, so that the receiving nodes or devices may turn themselves off, to avoid a situation wherein a receiving node or device may continue to listen for a Resume command that will not be sent. For example, an “expected” behavior of a user/application following receipt of a Stop command may include the user turning the device back on again, for example, only after the device has exited the sensitive area e.g., exited an airplane or an intensive care area, etc.

A sending node or device may issue a Stop, Pause, or Hibernate command for silencing a target device or network. The following guidelines may be used to best determine which command to use. A choice of commands may be based on the duration of the risk, which may be determined by a specific sensitive operation performed at the sensitive device.

For example, a Stop command may be used when a risk duration may be indefinite or very long, e.g., when a medical appliance such as a heart-lung machine may be used in an intensive care area.

As another example, a Pause command may be used when the risk may be temporary, and its duration may be unknown or long (relative to the maximum hibernation duration of the target system). A Pause/Resume command may be appropriate when the receiving part of the target device is not considered potentially dangerous; alternatively a Stop command or a sequence of Hibernate commands may be better choices, based for example on the duration of the risk and/or on the relative difference of EM-LEVs. For example, a Pause/Resume command may be appropriate for devices on an airplane between preparation for take-off and completion of landing.

As yet another example, a Hibernate command may be used when a risk duration may be known and comparable to the maximum hibernation duration of the target system. The Hibernate command may thus be more efficient than a Pause/Resume command for both a sensitive device and a target device.

A Warning command may optionally be sent before any of the commands discussed above.

A receiving node or target device that receives a Stop or a Pause command may inform upper layers of an unavailability of the link. Such an indication of the unavailability of the link to higher layers may trigger a transmission of a message to the application/user, which/who may switch the device off, or may at least be made aware of a reason for interruption of service.

The set of critical levels as described previously may be extended to range from very critical applications (e.g., military, medical, etc.) to lower critical level cases (e.g., churches, libraries, restaurants) in which operation of particular devices may be considered inappropriate although not dangerous. With this extension, EM-FRAMEs may be used to avoid inappropriate use of those particular devices in such cases.

However, for a case of silencing transmissions for reasons other than safety protection, all devices that may be targets of EM-FRAMEs may each have their own EM-LEV. For example, if EM-FRAMEs are sent only for safety protection, all target or receiving nodes or devices without an EM-LEV may be required to obey commands sent by a sending node or device. However, if EM-LEVs include intermediate levels as discussed above, the service interruption may be an unnecessarily burdensome solution for some applications. Therefore, it may be more appropriate to redefine the behavior such that a node or device receiving an EM-FRAME may obey the command from the current superframe or may interact with upper layers (e.g., application, user, etc.) and postpone the requested operations.

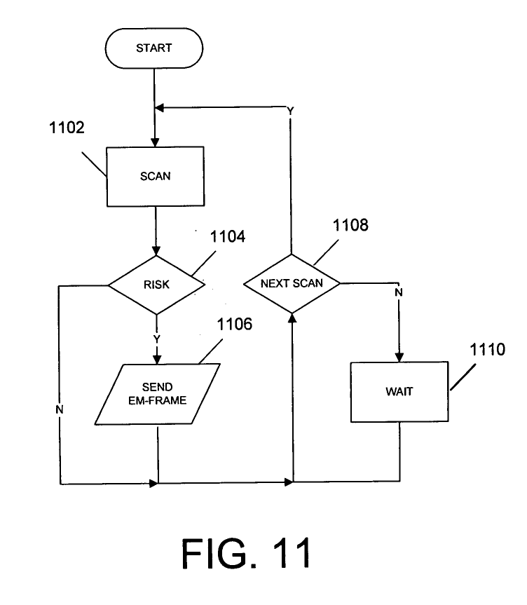

FIG. 11 is a flow chart illustrating operation of a wireless node sending a message according to an example embodiment. Scanning may be performed (1102), for example, on a wireless medium. If risk is detected by scanning (1104), an EM-FRAME may be sent (1106). For example, a sending node may send a message from the sending node to one or more receiving nodes requesting the receiving nodes to reduce transmissions on a wireless medium.

After sending the EM-FRAME (1106) or after negative assessment of risk (1104), it may be determined whether a next scan should be performed (1106). If a next scan should not e performed, the sending node may wait (1110) and check again to determine whether the next scan should be performed (1108). Eventually, the next scanning operation may be performed (1102). A delay condition (e.g., causing the wait (1110) to be performed) may be different depending on the previous step (e.g., depending on whether an EM-FRAME was transmitted (1106) or no risk was detected (1104)).

The sensitive device, for example, the sending node or device, may send its EM-FRAME one or more times. Thus, for systems having a superframe structure the sending node or device may send its EM-FRAME, for example, via one or more superframes, thus communicating the command to devices that may be in hibernation or that may be otherwise unreachable at the time of a first transmission of the EM-FRAME. The repetition of transmission may be performed multiple times to ensure that all devices of which the sending node or device is aware are available to receive the EM-FRAME.

With regard to WiMedia networks, the EM-FRAMEs may be sent preferably in signaling slots. As discussed previously, the EM-FRAMEs may be sent alternatively or additionally in regular beacon slots. The protocol for sending EM-FRAMEs in WiMedia signaling slots may differ from other beacons sent in WiMedia signaling slots. The sending node or device may, for example, send such beacons in the signaling slots within every superframe until the receiving nodes/devices/network have been silenced.

According to an example embodiment, the sending node or device may not send any beacon frame in slots other than signaling slots unless it has other reasons to do so. However, since there may be contention in WiMedia signaling slots, for example, the sending node or device may send an EM-FRAME in every signaling slot. Moreover, for example, the sending node or device may send EM-FRAMEs in other open beacon slots, but this may only slightly increase the probability of ensuring that the EM-FRAMES are received as desired.

The condition for the next transmission of the EM-FRAME (1104) may depend on a status of the sending node or device. For example, with regard to WiMedia networks, the sending node or device may send an EM-FRAME (e.g., an Emergency IE 900) in subsequent superframes, while continuing to check whether the command is obeyed by receiving nodes or devices, which may lead to a zero superframe delay until detection of an end of transmission activities of the target device(s) (e.g., the receiving nodes or devices). Thus, if no risk is detected at step 1104, the next scanning operation (1102) may optionally be delayed (1110), depending, for example, on an EM-LEV of the sending node or device and on other reasons such as a need to scan more target systems, a need to save energy, etc.

The sending node or device may send a command, indicated by the EM-OPS field, as discussed previously. As already discussed, at least four actions may be requested: Hibernation, which may last a known time; Pause, which may last for an indefinite time; Stop, which may last virtually forever (this solution may be drastic, but the decision on which command to issue may be left to the sending node or device); or a Warning may optionally be sent before one of the previous requests.

If the optional field EM-SIG is available, the sending node or device may use it to specify frequency bands and/or signaling methods to which the requested operation refers, thus minimizing any decrease in grade of service in the receiving node or devices as a result of the requested operation.

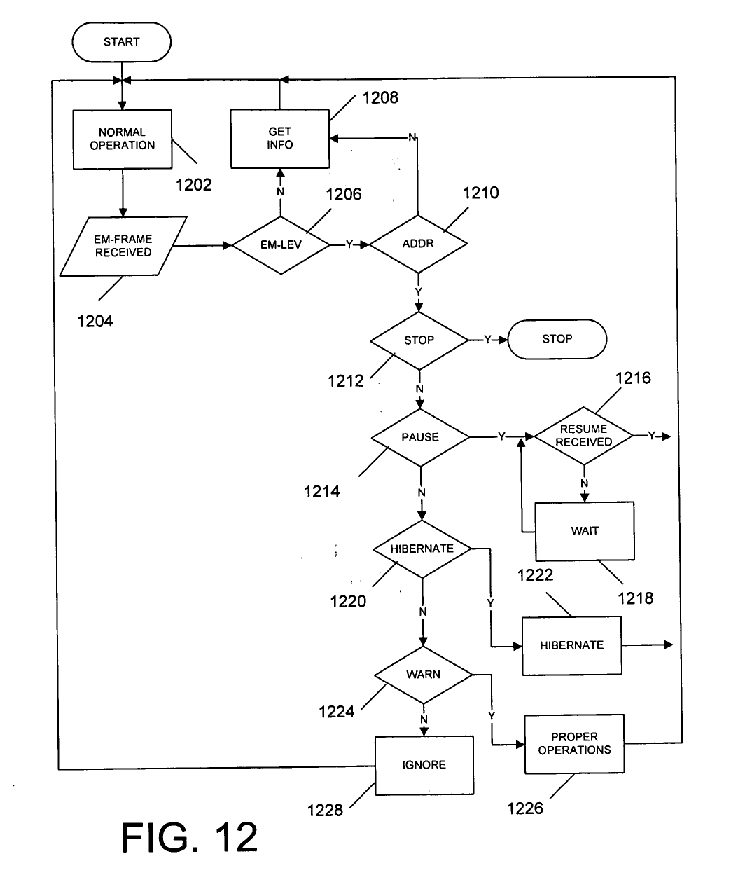

FIG. 12 is a flow chart illustrating operation of a wireless node receiving a message according to an example embodiment. During normal operation (1202) of the receiving node, an EM-FRAME may be received (1204). The receiving node may compare an EM-LEV included in the EM-FRAME with an EM-LEV of the receiving node (1206). If the receiving node has a lower priority than a sending node, and if the EM-FRAME command is of type “All” or if a DEV-ADDR included in the EM-FRAME matches an address of the receiving node (1210), the receiving node may further check the type of command and may behave in accordance with the protocol description.

For example, four tests including STOP (1212), PAUSE (1214), HIBERNATE (1220), and WARN (1224) may be performed in parallel, similarly to a SWITCH command. Thus, if a STOP command is received (1212), the receiving node may stop transmissions as discussed previously with regard to FIG. 10. If a PAUSE command is received (1214), the receiving node may stop transmissions (e.g., as discussed previously with regard to FIG. 10), until a resume command is received (1216, 1218), at which time normal operation may be resumed (1202).

If a HIBERNATE command is received (1220), the receiving node may hibernate (1222), for example, for a duration of hibernation indicated by an EM-HIB field included in the EM-FRAME as discussed previously, after which normal operation may be resumed (1202). If a WARN is received (1224), the receiving node may perform proper operations (1226), for example, by shutting down transmissions, or avoiding a sensitive area, as discussed previously, and normal operation may be resumed (1202).

If none of the previously discussed commands are received, the receiving node may ignore the EM-OPS field (1228), and normal operation may be resumed (1202).

If the receiving node does not have a lower priority than the sending node (1206) and/or if the receiving node is not the intended destination of the issued command (1210), in a GET INFO step (1208), information related to commands sent to other nodes or devices, known to the other nodes or devices, is obtained, and normal operation may be resumed or continued (1202).

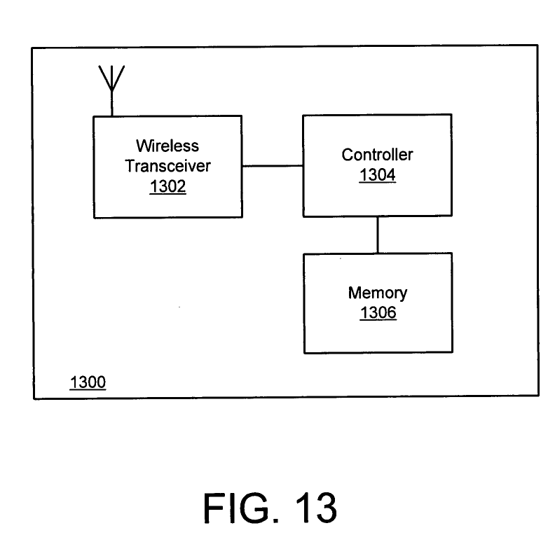

FIG. 13 is a block diagram illustrating an apparatus 1300 that may be provided in a wireless station according to an example embodiment. The wireless station may include, for example, a wireless transceiver 1302 to transmit and receive signals, a controller 1304 to control operation of the station and execute instructions or software, and a memory 1306 to store data and/or instructions. Controller 1304 may be programmable, and capable of executing software or other instructions stored in memory or on other computer media to perform the various tasks and functions described above. In addition, a storage medium or computer readable medium may be provided that includes stored instructions, that, when executed by a controller or processor, may result in the controller (e.g., the controller 1304) performing one or more of the functions or tasks described above.

Implementations of the various techniques described herein may be implemented in digital electronic circuitry, or in computer hardware, firmware, software, or in combinations of them. Implementations may implemented as a computer program product, i.e., a computer program tangibly embodied in an information carrier, e.g., in a machine-readable storage device or computer readable medium or in a propagated signal, for execution by, or to control the operation of, a data processing apparatus, e.g., a programmable processor or multiple processors, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

While certain features of the described implementations have been illustrated as described herein, many modifications, substitutions, changes and equivalents will now occur to those skilled in the art. It is, therefore, to be understood that the appended claims are intended to cover all such modifications and changes as fall within the true spirit of the various embodiments.

What is claimed is:

1. A method comprising:
sending a message from a sending node to one or more receiving nodes requesting the receiving nodes to reduce transmissions on a wireless medium, wherein the sending node and the receiving nodes are included in a distributed wireless network.

2. The method of claim 1 wherein:
control of the distributed wireless network is substantially equally distributed among the sending node and each of the one or more receiving nodes.

3. The method of claim 1 wherein:
the sending the message requesting the receiving nodes to reduce transmissions comprises sending a beacon frame in one or more signaling slots included in a superframe.

4. The method of claim 3 wherein:
the one or more signaling slots comprise beacon slots positioned at the beginning of the superframe.

5. The method of claim 3 wherein:
the beacon frame includes an indicator of an emergency type of the beacon frame.

6. The method of claim 1 wherein:
the sending the message requesting the receiving nodes to reduce transmissions comprises sending a beacon frame including an emergency information element in one or more signaling slots included in a superframe.

7. The method of claim 6 wherein:
the emergency information element includes an indicator of a critical level associated with the sending node.

8. The method of claim 6 wherein:
the emergency information element includes an indicator of one or more signaling bands or signaling methods for which the one or more receiving nodes are requested to reduce transmissions by the sending node.

9. The method of claim 6 wherein:
the emergency information element includes an indicator of a hibernation duration requested of the one or more receiving nodes by the sending node.

10. The method of claim 6 wherein:
the emergency information element includes an indicator of one or more operations requested of the one or more receiving nodes by the sending node.

11. The method of claim 10 wherein the one or more operations requested of the one or more receiving nodes by the sending node includes one or more of:
a stop all operation, including at least one of the receiving nodes stopping all transmissions or signaling methods indicated by the beacon frame;
a stop device operation, including at least one of the receiving nodes determining whether a device address included in the emergency information element matches an address of the at least one of the receiving nodes, and stopping all transmissions or signaling methods indicated by the beacon frame if it is determined that the device address matches the address of the at least one of the receiving nodes;
a pause all operation, including at least one of the receiving nodes suspending all transmissions or signaling methods indicated by the beacon frame and listening for an indication of a request to resume transmissions;
a pause device operation, including at least one of the receiving nodes determining whether a device address included in the emergency information element matches an address of the at least one of the receiving nodes, and suspending all transmissions or signaling methods indicated by the beacon frame if it is determined that the device address matches the address of the at least one of the receiving nodes and listening for an indication of a request to resume transmissions;
a resume all operation, including at least one of the receiving nodes resuming all transmissions or signaling methods indicated by the beacon frame;
a resume device operation, including at least one of the receiving nodes determining whether a device address included in the emergency information element matches an address of the at least one of the receiving nodes, and resuming all transmissions or signaling methods indicated by the beacon frame if it is determined that the device address matches the address of the at least one of the receiving nodes;
a hibernate all operation, including at least one of the receiving nodes hibernating for an interval indicated by the beacon frame; or
a hibernate device operation, including at least one of the receiving nodes determining whether a device address included in the emergency information element matches an address of the at least one of the receiving nodes, and hibernating for an interval indicated by the beacon frame if it is determined that the device address matches the address of the at least one of the receiving nodes.

12. The method of claim 1 further comprising:
scanning the wireless medium at the sending node to determine whether the one or more receiving nodes are participating in the distributed wireless network by periodically transmitting beacons during a repeated interval, wherein the scanning is performed periodically, aperiodically, or continuously.

13. A method comprising:
sending a message from a sending node to one or more receiving nodes alerting the receiving nodes that the receiving nodes are approaching an area in which the receiving nodes are instructed to reduce transmissions on a wireless medium, wherein the sending node and the receiving nodes are included in a distributed wireless network.

14. The method of claim 13 wherein control of the distributed wireless network is substantially equally distributed among the sending node and each of the one or more receiving nodes.

15. The method of claim 13 wherein the sending the message alerting the receiving nodes comprises sending a beacon frame in one or more signaling slots included in a superframe, wherein the beacon frame includes an indicator of one or more of:
a warn all operation, including at least one of the receiving nodes determining preparations for revising transmissions or signaling methods indicated by the beacon frame or for residual effects of entry into the area; or
a warn device operation, including at least one of the receiving nodes determining whether a device address included in the emergency information element matches an address of the at least one of the receiving nodes, and determining preparations for revising transmissions or signaling methods indicated by the beacon frame or for residual effects of entry into the area it is determined that the device address matches the address of the at least one of the receiving nodes.

16. The method of claim 13 further comprising:
scanning the wireless medium at the sending node to determine whether the one or more receiving nodes are approaching the area, wherein the scanning is performed periodically, aperiodically, or continuously.

17. A method comprising:
receiving a request from a sending node at a receiving node requesting the receiving node to reduce transmissions on a wireless medium, wherein the sending node and the receiving node are included in a distributed wireless network.

18. The method of claim 17 wherein:
the receiving the request comprises receiving a beacon frame in one or more signaling slots included in a superframe.

19. The method of claim 17 further comprising:
determining whether the request includes a control indicator to control the receiving node to comply with the request.

20. The method of claim 19 wherein:
the determining comprises determining whether the receiving node includes a critical level having a lower priority than a critical level included in the request.

21. A method comprising:
receiving a message from a sending node at a receiving device alerting the receiving device that the receiving device is approaching an area in which the receiving device is instructed to reduce transmissions on a wireless medium, wherein the sending node and the receiving device are included in a distributed wireless network.

22. The method of claim 21 further comprising:
sending an alert message to an application or to a protocol or entity included in the receiving device instructing the application to inform a user, or instructing the protocol or entity of the receiving device to prepare for reducing transmissions on the wireless medium or to move the receiving device away from the area.

23. An apparatus for wireless communications, the apparatus comprising:
a controller;
a memory coupled to the controller; and
a wireless transceiver coupled to the controller;
the apparatus adapted to:
send a message via the wireless transceiver requesting any of one or more devices receiving the message to reduce transmissions on a wireless medium, wherein the apparatus and the any of one or more devices are included in a distributed wireless network.

24. The apparatus of claim 23 wherein:
the message includes a beacon frame transmitted in one or more signaling slots included in a superframe, the beacon frame including an emergency information element indicating information associated with the request to reduce transmissions.

25. An apparatus for wireless communications, the apparatus comprising:
a controller;
a memory coupled to the controller; and
a wireless transceiver coupled to the controller;
the apparatus adapted to:
receive a request via the wireless transceiver requesting the apparatus to reduce transmissions on a wireless medium, wherein a device transmitting the message and the apparatus are included in a distributed wireless network.

26. A computer program product for wireless communications, the computer program product being tangibly embodied on a computer-readable medium and including executable code that, when executed, is configured to cause one or more processors to:
send a message from a sending node to one or more receiving nodes requesting the receiving nodes to reduce transmissions on a wireless medium, wherein the sending node and the receiving nodes are included in a distributed wireless network.

27. A computer program product for wireless communications, the computer program product being tangibly embodied on a computer-readable medium and including executable code that, when executed, is configured to cause one or more processors to:
receive a request from a sending node at a receiving node requesting the receiving node to reduce transmissions on a wireless medium, wherein the sending node and the receiving node are included in a distributed wireless network.

28. A communications signal embodied in a wireless communications medium comprising:
a beacon message including an emergency information element indicating information associated with a request to reduce transmissions.
